(19) United States
(12) Patent Application Publication
(10) Pub. No.: US 2015/0141304 A1
(43) Pub. Date: May 21, 2015

(54) Low-Density Downhole Fluids and Uses Thereof

(71) Applicant: BAKER HUGHES INCORPORATED, Houston, TX (US)

(72) Inventors: Marcus Davidson, Inverurie (GB); Stephen Richard Vickers, Alford (GB)

(73) Assignee: BAKER HUGHES INCORPORATED, Houston, TX (US)

(21) Appl. No.: 14/410,811

(22) PCT Filed: Jun. 19, 2013
(86) PCT No.: PCT/US13/46632

§ 371 Date: Dec. 23, 2014

Related U.S. Application Data
(60) Provisional application No. 61/666,039, filed on Jun. 29, 2012.

(51) Int. Cl. C09K 8/03

(52) U.S. Cl. CPC C09K 8/032
USPC 507/269

(57) ABSTRACT

A downhole fluid may be circulated within a wellbore where the downhole fluid may include at least a modified perlite and/or an aerogel. The amount of the modified perlite and/or aerogel within the downhole fluid may range from about 5 vol % to about 30 vol % of the downhole fluid of the total amount of the downhole fluid. The downhole fluid may be a drilling fluid, completion fluid, lost circulation pill, displacement pill, and combinations thereof. The material may help the downhole fluid maintain a relatively low density of less than about 1100 kg/m³.

### TECHNICAL FIELD

The present invention relates to low density downhole fluids, and more particularly relates, in one non-limiting embodiment, to downhole fluids that may be circulated within a wellbore where the downhole fluid comprises a material, such as a modified perlite and/or an aerogel where the downhole fluid may have a density less than about 1100 kg/m³.

### BACKGROUND

When drilling depleted reservoirs, such as those used for gas storage or carbon dioxide sequestration, there is usually an unacceptably large overbalance pressure within the wellbore. An ‘overbalance’ pressure occurs when the amount of pressure (or force per unit area) in the wellbore exceeds the pressure of fluids in the formation. However, excessive overbalance may slow the drilling process by effectively strengthening the near-wellbore rock and limiting removal of drilled cuttings under the bit. In addition, high overbalance pressures coupled with poor mud properties can cause differential sticking problems. Excessive overbalance can also cause fracture of the formation that may lead to the loss of drilling fluids within the formation and/or may lead to an abandonment of the wellbore. Many downhole fluids can have a density of over 2000 kg/m³, which contributes to the excessive overbalance of pressure within the wellbore.

Drilling fluids are typically classified according to their base fluid. In water-based fluids, solid particles are suspended in a continuous phase consisting of water or brine. Oil can be emulsified in the water, which is the continuous phase. “Water-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

Oil-based fluids are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in-non-aqueous emulsion, a brine-in-oil emulsion, or a brine-in-non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends. Oil-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

A ‘pill’ as used with regards to the recovery of oil and/or gas is any relatively small quantity, such as less than 200 bbl, of a special blend of products to accomplish a specific task that a conventional drilling fluid cannot perform. One example of this is a lost circulation pill used for reducing the amount of a downhole fluid being lost in the formation. Another example of a pill is a displacement pill that may be used to force a cement slurry out of the casing string and into the annular space between the casing and the wellbore.

There are a variety of functions and characteristics that are expected of completion fluids. The completion fluid may be placed in a well to facilitate final operations prior to initiation of production. Completion fluids are typically brines, such as chlorides, bromides, formates, but may be any non-damaging fluid having proper density and flow characteristics. Chemical compatibility of the completion fluid with the reservoir formation and fluids is key. Water-thickening polymers serve to increase the viscosity of the brines and thus retard the migration of the brines into the formation and lift drilled solids from the wellbore. A regular drilling fluid is usually not compatible for completion operations because of its solid content, pH, and ionic composition. Completion fluids also help place certain completion-related equipment, such as gravel packs, without damaging the producing subterranean formation zones.

The increasing number of open hole horizontal well completions in low-pressure and depleted reservoirs requires the use of low-density downhole fluids to avoid formation damage and for optimum well productivity. Oil-based downhole fluids have a lower density than water-based downhole fluids, but many additives for lowering the density of the downhole fluid are hydrophilic. To disperse the hydrophilic additives, a water-wetting agent or a surfactant, is usually added to the fluid, but this increases the weight and the density of the downhole fluid.

Thus, it would be desirable to have cost effective mechanisms for lowering the density of downhole fluid compositions and methods of using such compositions.

### SUMMARY

There is provided, in one form, a method for circulating a downhole fluid within a wellbore where the downhole fluid is a drilling fluid, completion fluid, lost circulation pill, displacement pill, and combinations thereof. The downhole fluid may include a material, such as but not limited to, a treated expanded perlite, a coated expanded perlite, a modified perlite combined with an aerogel, and combinations thereof. The amount of the material within the downhole fluid may range from about 5 vol % to about 30 vol % of the downhole fluid. The density of the downhole fluid may be less than about 1100 kg/m³.

In another embodiment, a downhole fluid composition is provided. The downhole fluid may include a base fluid and a material. The base fluid may be or include a drilling fluid, a completion fluid, a lost circulation pill, a displacement pill, and combinations thereof. The material may be or include, but is not limited to, a treated expanded perlite, a coated expanded perlite, a modified perlite combined with an aerogel, and combinations thereof. The material may be present in the downhole fluid in an amount ranging from about 5 vol % to about 30 vol % of the total downhole fluid composition. The downhole fluid may have a density less than about 1100 kg/m³.

The material in the downhole fluid appears to lower the density of the downhole fluid as compared to another downhole fluid absent the material.

### DETAILED DESCRIPTION

It has been discovered that adding a material to a downhole fluid may allow the downhole fluid to maintain a low density, such as but not limited to less than about 1100 kg/m³. Alternatively, the density of the fluid may range from about 600 kg/m³ independently to about 1100 kg/m³, or from about 600 kg/m³ independently to about 700 kg/m³ in another non-limiting embodiment, where “independently” as used herein means that any lower threshold may be combined with any upper threshold to define an acceptable alternative range. The material within the downhole fluid may maintain the low density of the downhole fluid under a condition, such as but not limited to, a temperature ranging from about 50° C. to about 150° C., a pressure ranging from about 5000 psi to about 15000 psi, a time period of the downhole fluid within the wellbore ranging from about 1 hour to about 120 hours, and combinations thereof.

The material may be an aerogel material and/or a modified perlite material. The aerogel material may be or include, but is not limited to, silica aerogels, alumina aerogels, tin oxide aerogels, chromia aerogels, iron oxide aerogels, and combinations thereof.

Perlite generally comprises any glass rock with the capacity to expand greatly on heating, such as but not limited to volcanic glass of rhyolitic composition, containing 2 to 5 percent of combined water. Perlite is generally characterized by a system of concentric, spheroidal cracks that may also be called perlite structure. Expanded perlite denotes any glass rock and more particularly a volcanic glass that has expanded suddenly or “popped” when heated rapidly. This “popping” may occur when the grains of crushed perlite are heated to the temperatures of incipient fusion. The contained water may be converted to steam and the crushed particles form light, fluffy, cellular particles. The volume of the particles may increase at least ten fold. Different types of perlite are characterized by variations in the composition of the glass affecting properties, such as softening point, type and degree of expansion, size of the bubbles and wall thickness between them, and porosity of the product. See generally; Encyclopedic Dictionary of Industrial Technology, Materials, Processes and Equipment, (1984) pages 226-227 and Grant; Hackh's Chemical Dictionary, The Blakiston Company Inc., 3rd Edition (1944).

“Perlite” as used herein is defined as an unmodified perlite. Unmodified perlite has a density of about 1100 kg/m³, while expanded perlite (i.e. one form of modified perlite) has a density of about 30-150 kg/m³. The low density of expanded perlite helps the downhole fluid to maintain a low density without substantially increasing the weight of the fluid.

Perlite in its unmodified state is a hydrophilic material that readily disperses in water or other aqueous-based fluids. To disperse perlite in oil, an oil-wetting agent may be used. Alternatively, the perlite may be a modified perlite that can disperse better in oil without the need for an oil-wetting agent than the unmodified perlite. The modified perlite may be or include, such as but not limited to, an expanded perlite, a treated expanded perlite, a coated expanded perlite, hydrophobically modified expanded perlite, and combinations thereof. Suitable oil-wetting agents include, but are not necessarily limited to OMNI-COTE, BIO-COTE, CLAY-COTE™ and SURF-COTE wetting agents available from Baker Hughes. The expanded perlite may also be a hydrophobic expanded perlite in one non-limiting embodiment. The expanded perlite, coated expanded perlite, and/or treated expanded perlite may maintain the internal pore structure and low density attributes of the specific modified perlite when used under extreme conditions, such as those expected in a downhole environment, e.g. an oil well.

A non-limiting example of a ‘treated expanded perlite’ involves treating the expanded perlite with a silane emulsion where the expanded perlite may be or include, but is not limited to, a hydrophobic expanded perlite, such as one prepared by a method similar to that described in U.S. Pat. No. 4,889,747 entitled “Hydrophobic Expanded Perlite Compositions and Process for Preparing the Same”. The resultant hydrophobic expanded perlite compositions may have improved dispersion in hydrophobic or organic fluids, such as downhole fluids, improved hydrolytic and storage stability, reduced water absorption, and combinations thereof.

The expanded perlite may also be modified by a method, such as that described in U.S. Pat. No. 3,769,065 entitled “Method of Coating Perlite and Producing Materials of Construction”. The first step is to apply an aqueous acid solution to the expanded perlite particles. The aqueous acid solution may be or include, but is not limited to acetic acid, hydrochloric acid, phosphoric acid, nitric acid, sulfuric acid, boric acid, formic acid, propionic acid, butanoic acid, malic acid, citric acid, and combinations thereof. Then, a sodium silicate may be applied to the moistened particles followed by another application of an aqueous acid solution. The particles may be dried for subsequent use in a downhole fluid. This type of coating applied to the expanded perlite may enhance the structural characteristics of the expanded perlite within the downhole fluid and is one non-limiting example of a ‘coated expanded perlite’.

Aerogels have an extremely low density because of their synthetic porous material derived from a gel where the liquid component of the gel has been extracted through supercritical drying. This allows the liquid to be slowly drawn off without causing the solid matrix in the gel to collapse from capillary action, as would happen with conventional evaporation. The first aerogels were produced from silica gels. Silica aerogels have a density ranging from about less than 1 kg/m³ (e.g. a silica aerogel nanofoam) to about 4 kg/m³ and are known as the lowest density types of solids. Aerogels were later produced from gels using alumina, chromia, iron oxide, and tin dioxide.

Despite their name, aerogels are rigid, dry materials and do not resemble a gel in their physical properties. The name simply notes the origin of the aerogel material as being derived from a gel. Its impressive load bearing abilities are due to the dendritic microstructure, in which spherical particles having an average size of about 2-5 nm are fused together into clusters. These clusters form a three-dimensional highly porous structure of almost fractal chains, with pores just under 100 nm. The average size and density of the pores can be controlled during the manufacturing process. Thus, aerogels may maintain a lower density downhole fluid than downhole fluids absent the aerogels, as well as maintaining the low density characteristic of the downhole fluid under extreme conditions within a wellbore.

There is a risk of attrition when a solid material is added to a downhole fluid, e.g. a drilling fluid in one non-limiting example. The perlite spheres or modified perlite spheres may be susceptible to the effects of mechanical crushing and abrasion by the drill string over several circulations. The spheres may break up into a number of smaller particles, and thereby decrease their benefit to the drilling fluid. This phenomenon may be counteracted by removing at least a portion of the perlite spheres and fragmented parts once they have been circulated down the drill string, through the bit and up the annulus. Upon their return to the surface, the solids control equipment on the rig may remove the perlite spheres and fragmented particles along with drilled solids for subsequent addition of new perlite material to the surface-active pit and pumped down hole. This may allow for a steady concentration of whole perlite spheres to be present in the circulating system, while still maintaining a low density for the downhole fluid.

The downhole fluid may be circulated within a wellbore where the drilling fluid may be or include a drilling fluid, a completion fluid, a lost circulation pill, a displacement pill, and combinations thereof. The base fluid may be a non-aqueous fluid (or oil-based fluid) or an aqueous fluid (or water-based fluid), or the base fluid may be a single-phase fluid, or a poly-phase fluid, such as an emulsion of oil-in-water (O/W) or water-in-oil (W/O). The amount of the material within the downhole fluid may be up to 50 vol % of the downhole fluid, or alternatively may range from about 5 vol % independently to about 30 vol %, or from about 10 vol % independently to about 25 vol % in another non-limiting embodiment.

The downhole fluid may also include a surfactant to better disperse the material into the downhole fluid, such as but not limited to nonionic surfactants, anionic surfactants, cationic surfactants, amphoteric surfactants, zwitterionic surfactants, extended surfactants, and combinations thereof. Surfactants are generally considered optional, but may be used to improve the quality of the dispersion of the material. Such surfactants may be present in the base fluids in amounts from about 0 vol % independently to about 2 vol %, alternatively from about 0.1 vol % independently to about 0.5 vol %.

Expected suitable surfactants may include, but are not necessarily limited to non-ionic, anionic, cationic, amphoteric surfactants and zwitterionic surfactants, janus surfactants, and blends thereof. Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension and an ionic or nonionic polar group. Other suitable surfactants may be dimeric or gemini surfactants, cleavable surfactants, janus surfactants and extended surfactants, also called extended chain surfactants.

The invention will be further described with respect to the following Examples, which are not meant to limit the invention, but rather to further illustrate the various embodiments.

### EXAMPLE 1

A drilling fluid, or drilling mud, had an expanded perlite mixed thereinto. Each component and its respective amount is listed in Table 1 below. The components were mixed by a method known to those skilled in the art of mixing drilling fluids.

TABLE 1

Product
Concentration

| Product | bbl/bbl | lb/bbl |
|---|---|---|
| CLAIRSOL | 0.67 | 185.55 |
| 370: a | | |
| mineral base | | |
| oil | | |
| CARBO-MUL | 0.02 | 6 |
| HT: a | | |
| polyamine | | |
| emulsifier | | |
| available | | |
| from Baker | | |
| Hughes | | |
| OMNI-COTE: | 0.03 | 11 |
| an oil- | | |
| wetting | | |
| agent | | |
| available | | |
| from Baker | | |
| Hughes | | |
| CARBO-VIS: | 0.03 | 15 |
| an | | |
| organophilic | | |
| clay | | |
| NF 2: a glycol | 0.02 | 6 |
| polar | | |
| activator | | |
| Expanded | 0.24 | 25 |
| Perlite | | |

The mud properties of the drilling fluid of Table 1 were measured and the results are listed in Table 2. The viscosity of the drilling fluid was measured with a FANN® 35 Viscometer, and the readings were taken at 600 rpm, 300 rpm, 200 rpm, 100 rpm, 6 rpm, and 3 rpm. The plastic viscosity (PV), yield point (YP), 10 s gels, 10 m gels, and mud weight (or density) were also measured. The density of the drilling fluid was 5.85 lb/gal, or about 701 kg/m³.

TABLE 2

| Mud | | |
|---|---|---|
| Properties | Value | Units |
| Fann 35 600 RPM | 207 | Dial |
| | | Reading |
| Fann 35 300 RPM | 94 | Dial |
| | | Reading |
| Fann 35 200 RPM | 63 | Dial |
| | | Reading |
| Fann 35 100 RPM | 32 | Dial |
| | | Reading |
| Fann 35 6 RPM | 8 | Dial |
| | | Reading |
| Fann 35 3 RPM | 6 | Dial |
| | | Reading |
| PV | 113 | cP |
| YP | 19 | lb/100 ft² |
| 10 s | 6 | lb/100 ft² |
| 10 m | 7 | lb/100 ft² |
| Mud Weight | 0.70 | g/cm³ |
| Mud Weight | 5.85 | lb/gal |

In the foregoing specification, the invention has been described with reference to specific embodiments thereof, and has been described as effective in providing methods and compositions for circulating a downhole fluid within a wellbore having a density less than about 1100 kg/m³. However, it will be evident that various modifications and changes can be made thereto without departing from the broader scope of the invention as set forth in the appended claims. Accordingly, the specification is to be regarded in an illustrative rather than a restrictive sense. For example, specific base fluids, perlites, aerogel materials, modified perlites, coatings and/or treatments of the perlite, and surfactants falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of a method for circulating a downhole fluid within a wellbore where the downhole fluid is a drilling fluid, a completion fluid, a lost circulation pill, a displacement pill, and combinations thereof where the downhole fluid has a density less than about 1100 kg/m³ and has a material that includes a modified perlite and/or an aerogel in an amount ranging from about vol 5% to about 30 vol % of the total downhole fluid. The downhole fluid composition may consist or consist essentially of a base fluid, such as drilling fluids, completion fluids, lost circulation pills, displacement pills, and combinations thereof; and a material that includes a modified perlite and/or an aerogel in an amount ranging from about 5 vol % to about 30 vol % of the total downhole fluid, and wherein the downhole fluid has a density less than about 1100 kg/m³.

The words “comprising” and “comprises” as used throughout the claims, are to be interpreted to mean “including but not limited to” and “includes but not limited to”, respectively.

1-18. (canceled)

19. A method comprising:
circulating a downhole fluid within a wellbore; wherein the downhole fluid is selected from the group consisting of drilling fluids, completion fluids, lost circulation pills, displacement pills, and combinations thereof; wherein the downhole fluid comprises a material selected from the group consisting of a treated expanded perlite, a coated expanded perlite, a modified perlite combined with an aerogel, and combinations thereof; wherein the material is present in the downhole fluid in an amount ranging from about 5 vol % to about 30 vol %; and wherein the downhole fluid has a density less than about 1100 kg/m³.

20. The method of claim 19, wherein the modified perlite is selected from the group consisting of an expanded perlite, a treated expanded perlite, a coated expanded perlite, and combinations thereof.

21. The method of claim 19, wherein the coated expanded perlite is an expanded perlite coated with a water-soluble silicate.

22. The method of claim 19, wherein the treated expanded perlite is an expanded perlite treated with a silane emulsion.

23. The method of claim 19, wherein the expanded perlite is a hydrophobic expanded perlite.

24. The method of claim 19, wherein the aerogel is selected from the group consisting of silica aerogels, alumina aerogels, tin oxide aerogels, chromia aerogels, iron oxide aerogels, and combinations thereof.

25. The method of claim 19, wherein the density of the downhole fluid is maintained under a condition selected from the group consisting of a temperature ranging from about 50 C to about 150 C, a pressure ranging from about 5000 psi to about 15000 psi, a time period ranging from about 1 hour to about 120 hours, and combinations thereof.

26. The method of claim 19, wherein the density of the downhole fluid ranges from about 600 kg/m³ to about 1100 kg/m³.

27. The method of claim 19, wherein the downhole fluid further comprises a surfactant selected from the group consisting of nonionic surfactants, anionic surfactants, cationic surfactants, amphoteric surfactants, zwitterionic surfactants, extended surfactants, and combinations thereof.

28. A downhole fluid composition comprising:
a base fluid selected from the group consisting of drilling fluids, completion fluids, lost circulation pills, displacement pills, and combinations thereof;
a material selected from the group consisting of a treated expanded perlite, a coated expanded perlite, a modified perlite combined with an aerogel, and combinations thereof; wherein the material is present in the downhole fluid in an amount ranging from about 5 vol % to about 30 vol %; and wherein the downhole fluid has a density less than about 1100 kg/m³; and
wherein the downhole fluid has a density less than about 1100 kg/m³.

29. The fluid composition of claim 28, wherein the modified perlite is selected from the group consisting of an expanded perlite, a treated expanded perlite, a coated expanded perlite, and combinations thereof.

30. The fluid composition of claim 28, wherein the coated expanded perlite is an expanded perlite coated with a water-soluble silicate.

31. The fluid composition of claim 28, wherein the treated expanded perlite is an expanded perlite treated with a silane emulsion.

32. The fluid composition of claim 28, wherein the expanded perlite is a hydrophobic expanded perlite composition.

33. The fluid composition of claim 28, wherein the aerogel is selected from the group consisting of silica aerogels, alumina aerogels, tin oxide aerogels, chromia aerogels, iron oxide aerogels, and combinations thereof.

34. The fluid composition of claim 28, wherein the density of the downhole fluid is maintained under a condition selected from the group consisting of a temperature ranging from about 50 C to about 150 C, a pressure ranging from about 5000 psi to about 15000 psi, a time period ranging from about 1 hour to about 120 hours, and combinations thereof.

35. The fluid composition of claim 28, wherein the density of the downhole fluid ranges from about 600 kg/m³ to about 1100 kg/m³.

36. The fluid composition of claim 28, wherein the downhole fluid further comprises a surfactant selected from the group consisting of nonionic surfactants, anionic surfactants, cationic surfactants, amphoteric surfactants, zwitterionic surfactants, extended surfactants, and combinations thereof.
